(19) United States
(12) Patent Application Publication
(10) Pub. No.: US 2020/0271987 A1
(43) Pub. Date: Aug. 27, 2020

(54) DISPLAY DEVICE

(71) Applicant: Samsung Display Co., Ltd., Yongin-Si (KR)

(72) Inventors: Saeron PARK, Gimhae-si (KR); KICHUL SHIN, Seongnam-si (KR); JinSuek KIM, Suwon-si (KR)

(21) Appl. No.: 16/736,101

(22) Filed: Jan. 7, 2020

(30) Foreign Application Priority Data
Feb. 22, 2019 (KR) 10-2019-0021211

(51) Int. Cl. G02F 1/1335; G02F 1/1343; G02F 1/1337; G02F 1/1368

(52) U.S. Cl. CPC G02F 1/133514; G02F 1/134363; G02F 1/133707; G02F 2001/134381; G02F 1/1368; G02F 2001/134372; G02F 1/13439

(57) ABSTRACT

A display device includes a first pixel circuit connected to a corresponding data line and a corresponding gate line, a second pixel circuit connected to a corresponding data line and a corresponding gate line, a first pixel electrode connected to the first pixel circuit and disposed in a first pixel area, a second pixel electrode connected to the second pixel circuit and disposed in a second pixel area, a first main color filter disposed in the first pixel area and having a first color, a second main color filter disposed in the second pixel area and having a second color, a first sub-color filter overlapping with the first pixel circuit and having the second color, a first light blocking layer extending in a second direction and overlapping with the gate line, and a second light blocking layer extending parallel to the data line from the first light blocking layer.

This application claims priority to Korean Patent Application No. 10-2019-0021211, filed on Feb. 22, 2019, and all the benefits accruing therefrom under 35 U.S.C. § 119, the content of which in its entirety is herein incorporated by reference.

### BACKGROUND

### 1. Field

The disclosure relates to a display device.

### 2. Description of the Related Art

In general, a display device includes a first substrate on which pixels are arranged, a second substrate facing the first substrate, and an image display layer disposed between the first substrate and the second substrate and driven by the pixels. In such a display device, various image display layers, such as a liquid crystal layer, an electrowetting layer and an eletrophoretic layer, are used as the image display layer.

In such a display device, each pixel may include a pixel electrode connected to a thin film transistor to receive a data voltage and a common electrode facing the pixel electrode to receive a common voltage. The image display layer may be driven by an electric field generated by the pixel electrode by receiving the data voltage and the common electrode by receiving the common voltage to display the image.

In such a display device, one of the first and second substrates may include a black matrix disposed in a non-pixel area of a display area or a non-display area to prevent a light leakage. In addition, column spacers may be disposed between the first and second substrates to maintain a cell gap between the first and second substrates. In general, the column spacers are arranged in the area in which the black matrix is disposed to prevent an aperture ratio of the display device from being lowered.

### SUMMARY

The disclosure provides a display device capable of simplifying a manufacturing process thereof and preventing a color mixture between pixels.

Embodiments of the invention provide a display device including a plurality of data lines extending in a first direction, a plurality of gate lines extending in a second direction, a first pixel circuit connected to a corresponding data line among the data lines and a corresponding gate line among the gate lines, a second pixel circuit connected to a corresponding data line among the data lines and a corresponding gate line among the gate lines, a first pixel electrode connected to the first pixel circuit and disposed in a first pixel area, a second pixel electrode connected to the second pixel circuit and disposed in a second pixel area, a first main color filter disposed in the first pixel area and having a first color, a second main color filter disposed in the second pixel area and having a second color, a first sub-color filter overlapping the first pixel circuit and having the second color, a first light blocking layer extending in the second direction and overlapping the gate lines, and a second light blocking layer extending in the first direction from the first light blocking layer.

Embodiments of the invention provide a display device including a plurality of data lines extending in a first direction, a plurality of gate lines extending in a second direction, a first pixel circuit connected to a corresponding data line among the data lines and a corresponding gate line among the gate lines, a second pixel circuit connected to a corresponding data line among the data lines and a corresponding gate line among the gate lines, a third pixel circuit connected to a corresponding data line among the data lines and a corresponding gate line among the gate lines, a first pixel electrode connected to the first pixel circuit and disposed in a first pixel area, a second pixel electrode connected to the second pixel circuit and disposed in a second pixel area, a third pixel electrode connected to the third pixel circuit and disposed in a third pixel area, a first main color filter disposed in the first pixel area and having a first color, a second main color filter disposed in the second pixel area and having a second color, a third main color filter disposed in the third pixel area and having a third color, a first sub-color filter overlapping the first pixel circuit and having a color different from the first color, a second sub-color filter overlapping at least one of the second and third pixel circuits, a first light blocking layer extending in the second direction and overlapping the gate lines, the first sub-color filter, and the second sub-color filter, and a second light blocking layer extending in the first direction from the first light blocking layer.

According to embodiments of the invention, the first substrate includes the light blocking layer disposed to correspond to the area in which two main color filters overlap each other. Therefore, a phenomenon that may occur when different color lights are mixed with each other between the pixel areas due to the overlap of the two main color filters may be effectively prevented from being perceived.

### BRIEF DESCRIPTION OF THE DRAWINGS

The above and other features of the invention will become readily apparent by reference to the following detailed description when considered in conjunction with the accompanying drawings, in which:

FIG. 1 is a perspective view showing a display device according to an exemplary embodiment of the disclosure;

FIG. 2 is a plan view showing the display device shown in FIG. 1;

FIG. 3 is a plan view showing a pixel area of a first substrate according to an exemplary embodiment of the disclosure;

FIG. 4 is a plan view showing the first substrate shown in FIG. 3, from which a light blocking layer shown in FIG. 3 is omitted;

FIG. 5 is a plan view showing a layout of a pixel circuit layer and a pixel electrode shown in FIG. 4;

FIG. 6 is a plan view showing a color filter layer according to an exemplary embodiment of the disclosure;

FIG. 7 is a plan view showing the color filter layer shown in FIG. 6 overlapping the light blocking layer;

FIG. 8A is a cross-sectional view taken along line I-I′ shown in FIG. 3 to show the first substrate;

FIG. 8B is a cross-sectional view taken along line II-IF shown in FIG. 3 to show the first substrate;

FIG. 9A is an enlarged view showing the portion III of the first substrate shown in FIG. 8A;

FIG. 9B is an enlarged view showing a first substrate according to an alternative exemplary embodiment of the disclosure;

FIG. 10A is a cross-sectional view showing the first substrate of FIG. 8A coupled to a second substrate;

FIG. 10B is a cross-sectional view showing the first substrate of FIG. 8B coupled to the second substrate;

FIG. 11 is a plan view showing a pixel area of a first substrate according to an exemplary embodiment of the disclosure;

FIG. 12 is a plan view showing the first substrate of FIG. 11, from which a light blocking layer is removed;

FIG. 13A is a cross-sectional view taken along line IV-IV′ shown in FIG. 11 to show the first substrate coupled to the second substrate;

FIG. 13B is a cross-sectional view taken along line V-V′ shown in FIG. 11 to show the first substrate coupled to the second substrate;

FIG. 14 is a plan view showing a pixel area of a first substrate according to an exemplary embodiment of the disclosure;

FIG. 15 is a plan view showing the first substrate of FIG. 14, from which a light blocking layer is removed;

FIG. 16A is a cross-sectional view taken along line VI-VI′ shown in FIG. 14 to show the first substrate coupled to the second substrate; and

FIG. 16B is a cross-sectional view taken along line VII-VII′ shown in FIG. 14 to show the first substrate coupled to the second substrate.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In the disclosure, It will be understood that when an element or layer is referred to as being “on”, “connected to” or “coupled to” another element or layer, it can be directly on, connected or coupled to the other element or layer or intervening elements or layers may be present.

It will be understood that when an element is referred to as being “on” another element, it can be directly on the other element or intervening elements may be present therebetween. In contrast, when an element is referred to as being “directly on” another element, there are no intervening elements present.

Like numerals refer to like elements throughout. In the drawings, the thickness, ratio, and dimension of components are exaggerated for effective description of the technical content.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one of A and B” means “A or B.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in detail with reference to the accompanying drawings.

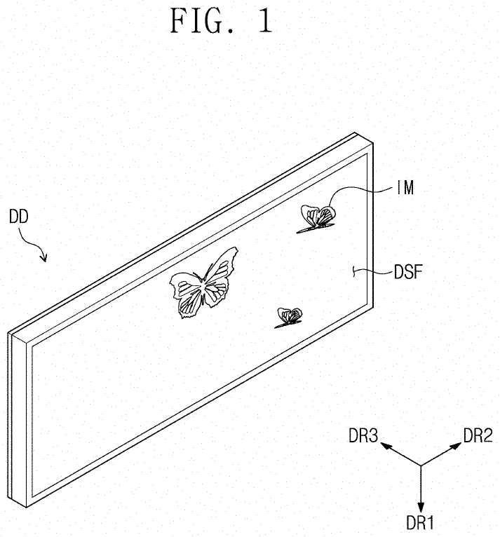

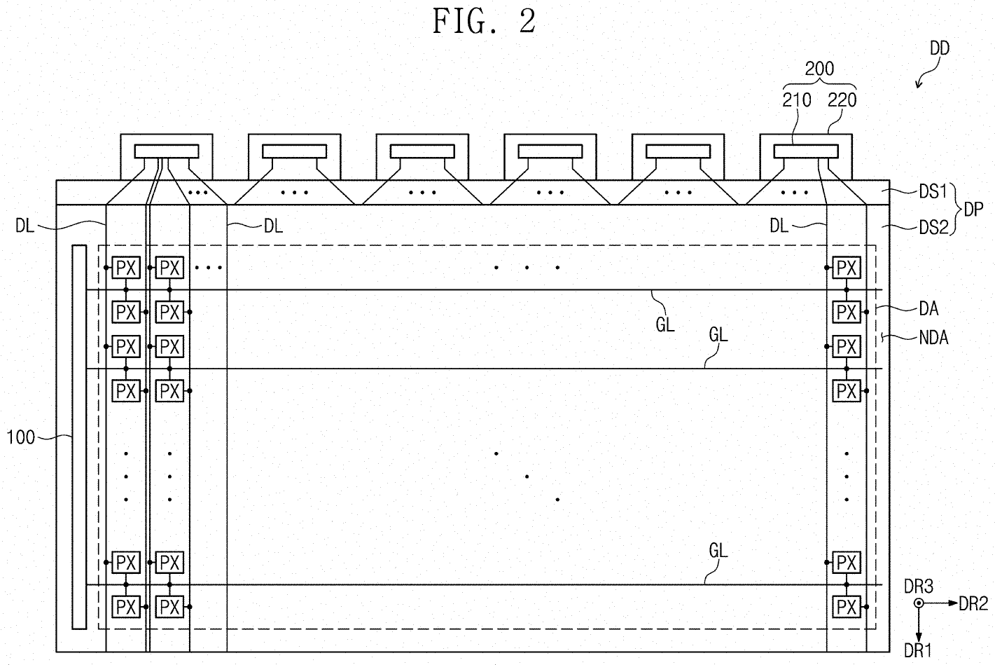

FIG. 1 is a perspective view showing a display device DD according to an exemplary embodiment of the disclosure. FIG. 2 is a plan view showing the display device DD shown in FIG. 1.

Referring to FIG. 1, the display device DD provides a user with an image IM through a display surface DSF thereof. In FIG. 1, a butterfly is shown as a representative example of the image IM displayed on the display device DD. The display surface DSF may be substantially parallel to a plane surface defined by a first direction DR1 and a second direction DR2. A third direction DR3 may be substantially perpendicular to the first direction DR1 and the second direction DR2. Here, the third direction DR3 may be a thickness direction of the display device DD.

Referring to FIG. 2, an exemplary embodiment of the display device DD includes a display panel DP, a gate driving circuit 100, and a data driving circuit 200.

The display panel DP is not limited to a particular type. In such an embodiment, various display panels, such as a liquid crystal display panel, an organic light emitting display panel, an electrophoretic display panel, and an electrowetting display panel, for example, may be used as the display panel DP. Hereinafter, for convenience of description, exemplary embodiments where the display panel DP is a liquid crystal display panel, will be described in detail. Such an embodiment of the display device DD or a liquid crystal display device including the liquid crystal display panel may further include a polarizing member (not shown) and a backlight unit (not shown).

The display panel DP includes a first substrate DS1, a second substrate DS2 spaced apart from the first substrate DS1, and a liquid crystal layer (not shown) disposed between the first substrate DS1 and the second substrate DS2. When viewed from a plan view in the third direction DR3, the display panel DP includes a display area DA in which a plurality of pixels PX is arranged and a non-display area NDA surrounding the display area DA. The display surface DSF shown in FIG. 1 corresponds to the display area DA.

The display panel DP includes a plurality of gate lines GL disposed on the first substrate DS1 and a plurality of data lines DL disposed on the first substrate DS1 to cross the gate lines GL. The gate lines GL are connected to the gate driving circuit 100. The data lines DL are connected to the data driving circuit 200.

FIG. 2 shows only some pixels among the pixels PX. Each of the pixels PX is connected to a corresponding gate line among the gate lines GL and a corresponding data line among the data lines DL.

The pixels PX may display one of primary colors. The primary colors may include a red color, a green color, a blue color and a white color, but not being limited thereto or thereby. Alternatively, the pixels PX may display one of mixed colors. The mixed colors may include a variety of colors, e.g., a yellow color, a cyan color and a magenta color.

The gate driving circuit 100 generates gate signals and outputs the generated gate signals to the gate lines GL.

FIG. 2 shows an exemplary embodiment where a single gate driving circuit 100 is connected to left ends of the gate lines GL, but the number and location of the gate driving circuits 100 are not limited thereto or thereby. In one alternative exemplary embodiment, for example, the display device DD may include two gate driving circuits respectively connected to left and right ends of the gate lines GL.

The data driving circuit 200 generates data signals corresponding to image data applied thereto. The data driving circuit 200 outputs the generated data signals to the data lines DL. Herein, the data signals may also be referred to as data voltages.

The data driving circuit 200 may include a data driver 210 and a flexible printed circuit board 220 on which the data driver 210 is disposed or mounted. Each of the data driver 210 and the flexible printed circuit board 220 may be provided in plural.

Each of the data drivers 210 applies data signals to corresponding data lines DL among the data lines DL.

FIG. 2 shows an exemplar embodiment where the data driving circuit 200 is provided in a chip-on-film (“COF”) method. According to an alternative exemplary embodiment, the data driver 210 may be disposed in the non-display area NDA of the first substrate DS1 in a chip-on-glass (“COG”) method.

Referring to FIG. 2, the pixels PX are arranged in a matrix form with a plurality of pixel rows and a plurality of pixel columns. The pixels PX included in each pixel row are arranged in the first direction DR1. The pixel rows are arranged in the second direction DR2. The pixels PX included in each pixel column are arranged in the second direction DR2. The pixel rows are arranged in the first direction DR1.

Each of the pixel columns may be connected to two data lines DL. In an exemplary embodiment, one data line of the two data lines DL is connected to odd-numbered pixels among the pixels PX of a pixel column, and the other data line of the two data lines DL is connected to even-numbered pixels among the pixels PX of the pixel column. In such an embodiment, two pixel rows adjacent to each other among the pixel rows may be connected to a single gate line GL.

Accordingly, the display device DD may be implemented using the gate lines GL, the number of which is half the number of the pixel rows, and thus a time spent to apply the gate signals may be further secured as compared with a structure in which the gate lines GL are provided in a same number as the pixel rows. In such an embodiment, the time during which the gate signals are applied is lengthened, such that an accuracy of the signals applied to the pixels becomes high, and thus a high-resolution display panel DP may be stably implemented.

However, the disclosure is not limited thereto or thereby. According to an alternative exemplary embodiment, each of the pixel columns may be connected to one corresponding data line DL, and each of the pixel rows may be connected to one corresponding gate line GL.

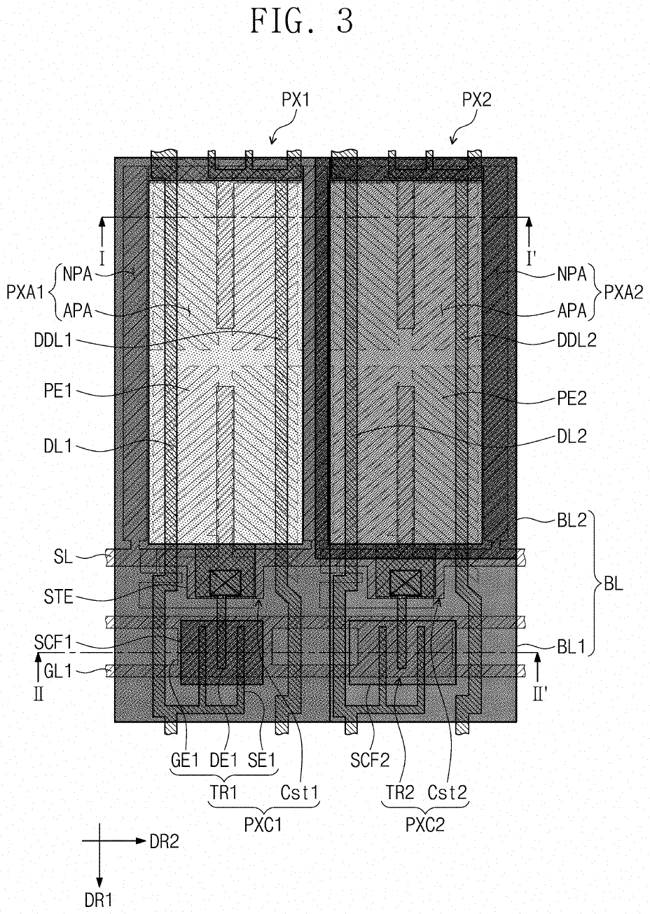

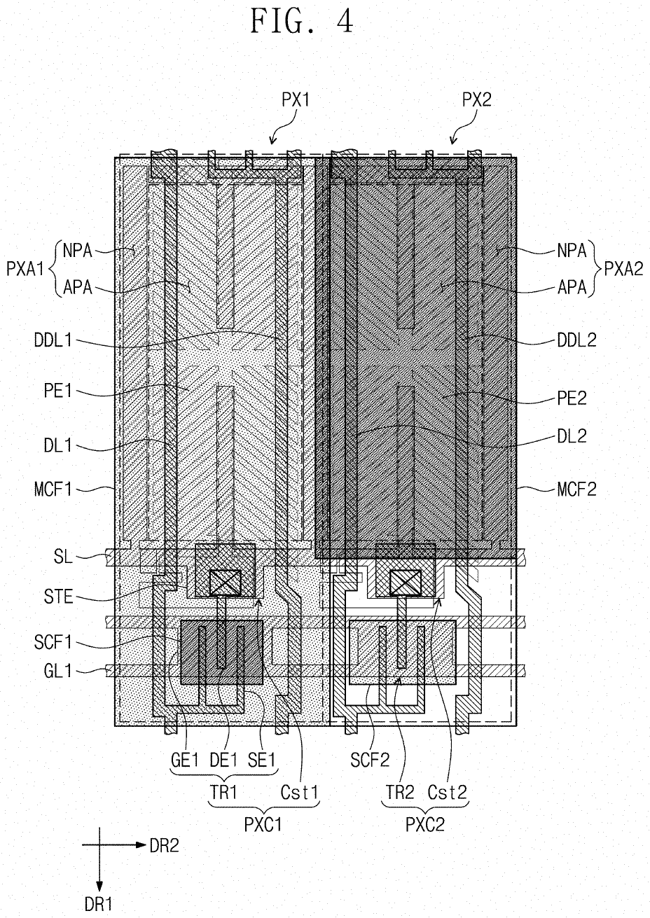

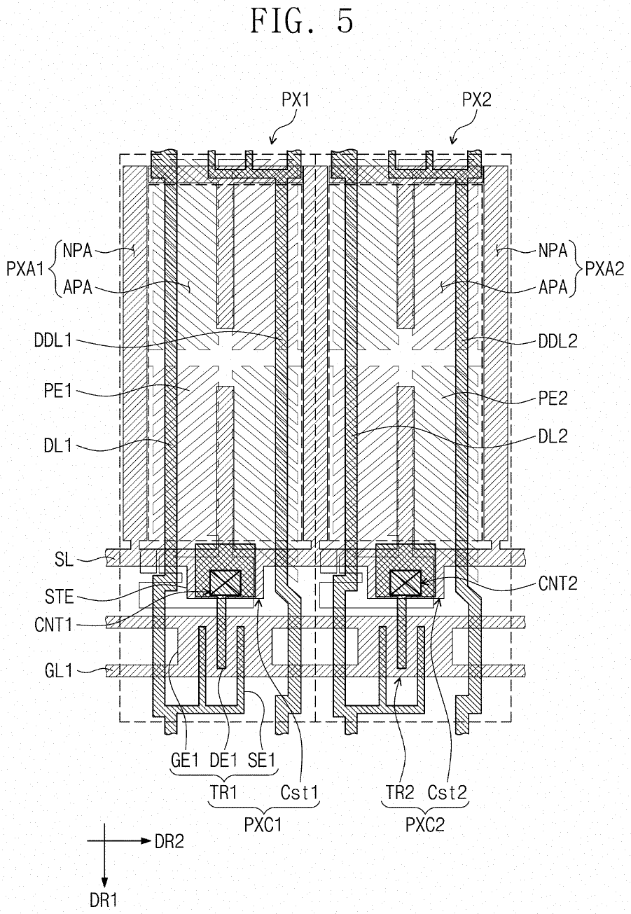

FIG. 3 is a plan view showing the pixel area of the first substrate according to an exemplary embodiment of the disclosure, FIG. 4 is a plan view showing the first substrate shown in FIG. 3, from which a light blocking layer shown in FIG. 3 is removed , and FIG. 5 is a plan view showing a layout of a pixel circuit layer and a pixel electrode shown in FIG. 4.

The display area DA (refer to FIG. 2) of the first substrate DS1 includes a plurality of pixel areas. FIGS. 3 to 5 show first and second pixel areas PXA1 and PXA2 among the pixel areas for convenience of illustration.

Referring to FIGS. 3 to 5, in an exemplary embodiment, the first substrate DS1 includes a first pixel PX1 disposed in the first pixel area PXA1 and a second pixel PX2 disposed in the second pixel area PXA2. The first pixel PX1 includes a first pixel circuit PXC1 and a first pixel electrode PE1, and the second pixel PX2 includes a second pixel circuit PXC2 and a second pixel electrode PE2. The first pixel circuit PXC1 is connected to a first gate line GL1 and a first data line DL1, and the second pixel circuit PXC2 is connected to the first gate line GL1 and a second data line DL2.

The first pixel area PXA1 includes an active pixel area APA and a non-active pixel area NPA. The first pixel electrode PE1 overlaps the active pixel area APA, and the first pixel circuit PXC1 overlaps the non-active pixel area NPA. The first gate line GL1 and the first and second data lines DL1 and DL2 are disposed in the non-active pixel area NPA. In an exemplary embodiment, portions of the first and second data lines DL1 and DL2 may overlap the active pixel area APA.

The first pixel electrode PE1 may have a pattern structure to divide the first pixel area PXA1 into a plurality of domains. In one exemplary embodiment, for example, the first pixel electrode PE1 may include a trunk portion having a cross shape in the first and second directions DR1 and DR2 and a plurality of branch portions extending radially or obliquely from the trunk portion. In such an embodiment, the first pixel area PXA1 may be divided into four domains. The branch portions in a same domain may extend substantially in parallel to each other and are spaced apart from each other in each domain. The branch portions adjacent to each other are spaced apart from each other in the unit of micrometer to form a plurality of micro-slits. However, the pattern structure of the first pixel electrode PE1 is not limited thereto or thereby.

The first pixel circuit PXC1 includes a first transistor TR1 and a first storage capacitor Cst1. The first transistor TR1 includes a first gate electrode GE1 extending from the first gate line GL1, a first source electrode SE1 extending from the first data line DL1, and a first drain electrode DE1 spaced apart from the first source electrode SE1. The first source electrode SE1 and the first drain electrode DE1 overlap the first gate electrode GE1. The first drain electrode DE1 overlaps the first pixel electrode PE1 and is electrically connected to the first pixel electrode PE1. The first pixel electrode PE1 is in a direct contact with the first drain electrode DE1 in a first contact portion CNT1.

The first storage capacitor Cst1 may include a first electrode connected to the first drain electrode DE1 and a second electrode STE extending from a storage lien SL. The first electrode may be integrally formed with the first drain electrode DE1 as a single unitary unit. The storage line SL is used to supply a storage voltage. The second electrode may overlap the first pixel electrode PE1. The storage line SL, the first electrode, and the second electrode STE may overlap the non-active pixel area NPA.

The second pixel circuit PXC2 includes a second transistor TR2 and a second storage capacitor Cst2, which are substantially the same as the first transistor TR1 and the first storage capacitor Cst1 of the first pixel circuit PXC1, and any repetitive detailed descriptions thereof will be omitted for convenience of description.

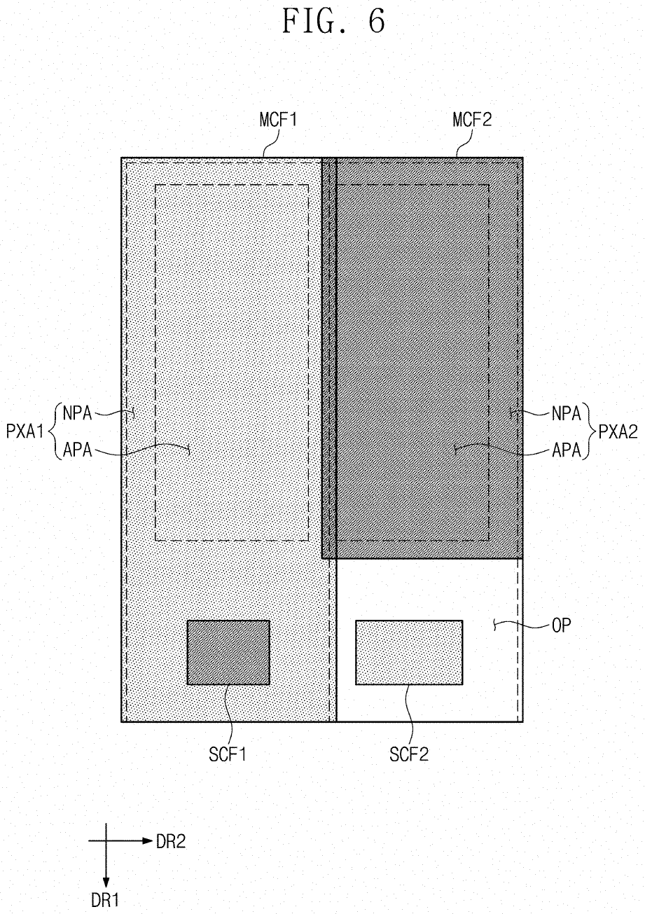

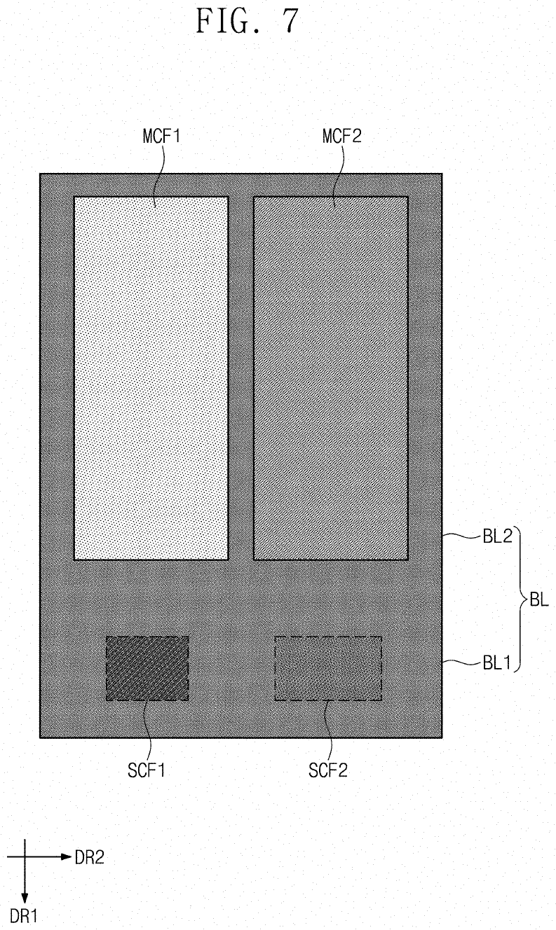

FIG. 6 is a plan view showing a color filter layer according to an exemplary embodiment of the disclosure, and FIG. 7 is a plan view showing the color filter layer shown in FIG. 6 overlapping a light blocking layer.

In an exemplary embodiment, as shown in FIGS. 3 to 7, the first substrate DS1 may include the light blocking layer BL that defines the non-active pixel area NPA. The light blocking layer BL may be disposed in the non-active pixel area NPA to cover the first pixel circuit PXC1 and the first gate line GL1. The light blocking layer BL may partially cover the first and second data lines DL1 and DL2. The light blocking layer BL may include a plurality of first light blocking layers BL1 and a plurality of second light blocking layers BL2. The first light blocking layers BL1 may extend in the second direction DR2 and may be spaced apart from each other while being arranged in the first direction DR1. The second light blocking layers BL2 may extend in the first direction DR1 and may be spaced apart from each other while being arranged in the second direction DR2. Each of the first light blocking layers BL1 may be connected to the second light blocking layers BL2. The second direction DR2 may be substantially perpendicular to the first direction DR1.

The first pixel circuit PXC1 and the first gate line GL1 are covered by one corresponding first light blocking layer among the first light blocking layers BL1. The first and second data lines DL1 and DL2 overlap the first light blocking layers BL1 and do not overlap the second light blocking layers BL2.

The second pixel area PXA2 includes the active pixel area APA and the non-active pixel area NPA. The second pixel circuit PXC2 has substantially a same structure as the first pixel circuit PXC1. The second pixel circuit PXC2 and the first pixel circuit PXC1 are covered by a corresponding first light blocking layer among the first light blocking layers BL1. The first pixel PX1 may include a first main color filter MCF1 disposed in the first pixel area PXA1, and the second pixel PX2 may include a second main color filter MCF2 disposed in the second pixel area PXA2. The first main color filter MCF1 may have a color different from a color of the second main color filter MCF2. The first main color filter MCF1 may be provided in plural, and the first main color filters MCF1 may be arranged in the second direction DR2. In an exemplary embodiment, the first main color filters MCF1 may be connected to each other, e.g., integrally formed with each other as a single unit.

The first main color filter MCF1 may be disposed in the active pixel area APA and the non-active pixel area NPA of the first pixel area PXA1. The first main color filter MCF1 may cover the first pixel circuit PXC1 in the non-active pixel area NPA. A portion of the first main color filter MCF1 in the active pixel area APA may have a same width as a portion of the first main color filter MCF1 in the non-active pixel area NPA.

The second main color filter MCF2 may be disposed in the active pixel area APA of the second pixel area PXA2. An opening OP is defined through the second main color filter MCF2 in the non-active pixel area NPA of the second pixel area PXA2. The second pixel circuit PXC2 may be partially exposed through the opening OP defined through the second main color filter MCF2. In such an embodiment, the second main color filter MCF2 may not overlap a second contact portion CNT2 of the second pixel circuit PXC2. The second contact portion CNT2 of the second pixel circuit PXC2 may be exposed through the opening OP.

The first main color filter MCF1 may be disposed to partially overlap the pixel area, e.g., the second pixel area PXA2, adjacent thereto. In one exemplary embodiment, for example, the first main color filter MCF1 may partially overlap the second main color filter MCF2.

The first pixel PX1 may include a first sub-color filter SCF1 disposed in the first pixel area PXA1, and the second pixel PX2 may include a second sub-color filter SCF2 disposed in the second pixel area PXA2. The first sub-color filter SCF1 may have a color different from that of the first main color filter MCF1. In one exemplary embodiment, for example, the first sub-color filter SCF1 may have substantially a same color as the second main color filter MCF2. The first sub-color filter SCF1 may be disposed on the first main color filter MCF1. The first sub-color filter SCF1 may be disposed in the non-active pixel area NPA to overlap the first pixel circuit PXC1. In an exemplary embodiment, the first sub-color filter SCF1 may overlap the first transistor TR1.

The second sub-color filter SCF2 may have a color different from a color of the second main color filter MCF2. In one exemplary embodiment, for example, the second sub-color filter SCF2 may have substantially a same color as the first main color filter MCF2.

The second sub-color filter SCF2 may not overlap the second main color filter MCF2. The second sub-color filter SCF2 may be disposed in the non-active pixel area NPA to overlap the second pixel circuit PXC2. In an exemplary embodiment, the second sub-color filter SCF2 may overlap a second transistor TR2.

In an exemplary embodiment, as shown in FIGS. 3 to 7, each of the first and second sub-color filters SCF1 and SCF2 has a quadrangular shape when viewed from a plan view, but the shape of the first and second sub-color filters SCF1 and SCF2 is not particularly limited thereto. In one alternative exemplary embodiment, for example, each of the first and second sub-color filters SCF1 and SCF2 may have a circular shape when viewed from a plan view.

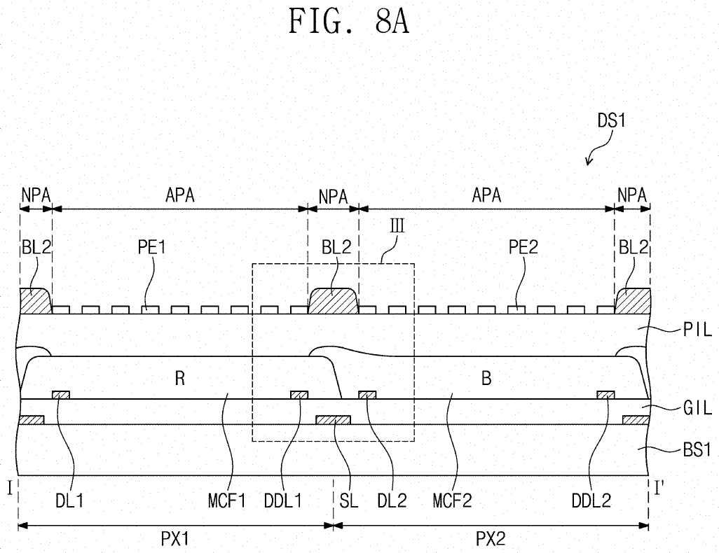

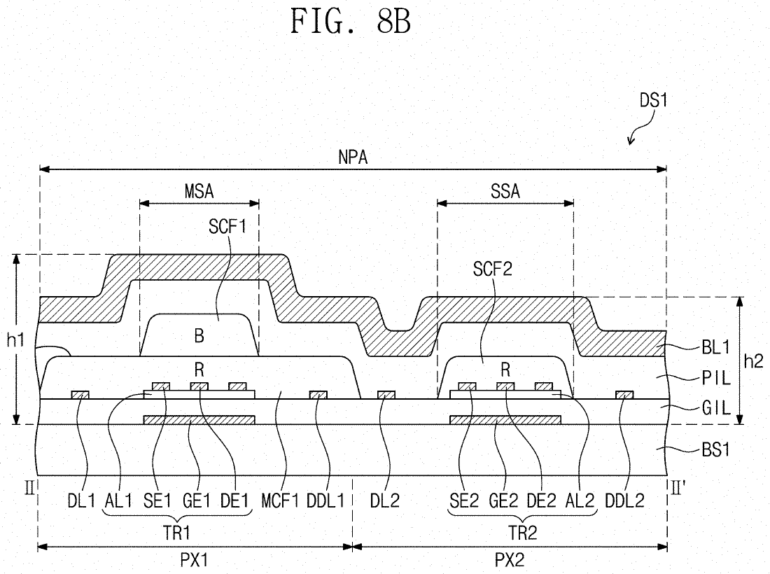

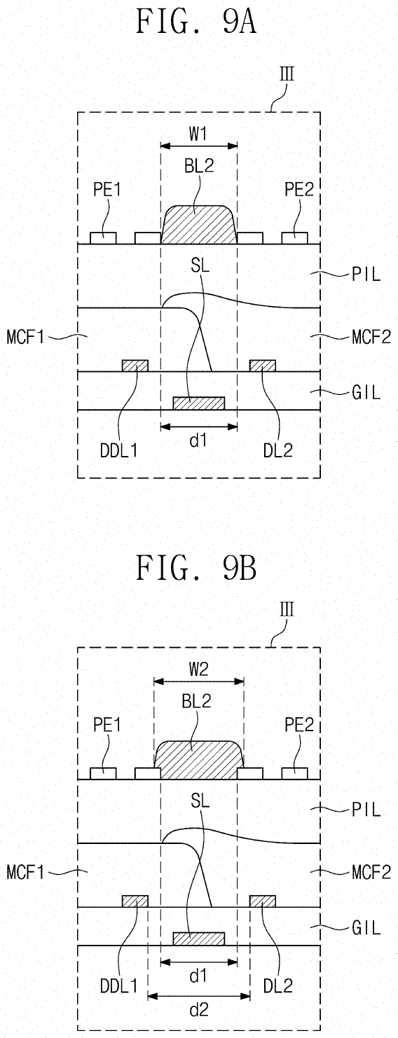

FIG. 8A is a cross-sectional view taken along line I-I′ shown in FIG. 3 to show the first substrate, and FIG. 8B is a cross-sectional view taken along line II-II′ shown in FIG. 3 to show the first substrate. FIG. 9A is an enlarged view showing the portion III of the first substrate shown in FIG. 8A, and FIG. 9B is an enlarged view showing a first substrate according to an alternative exemplary embodiment of the disclosure.

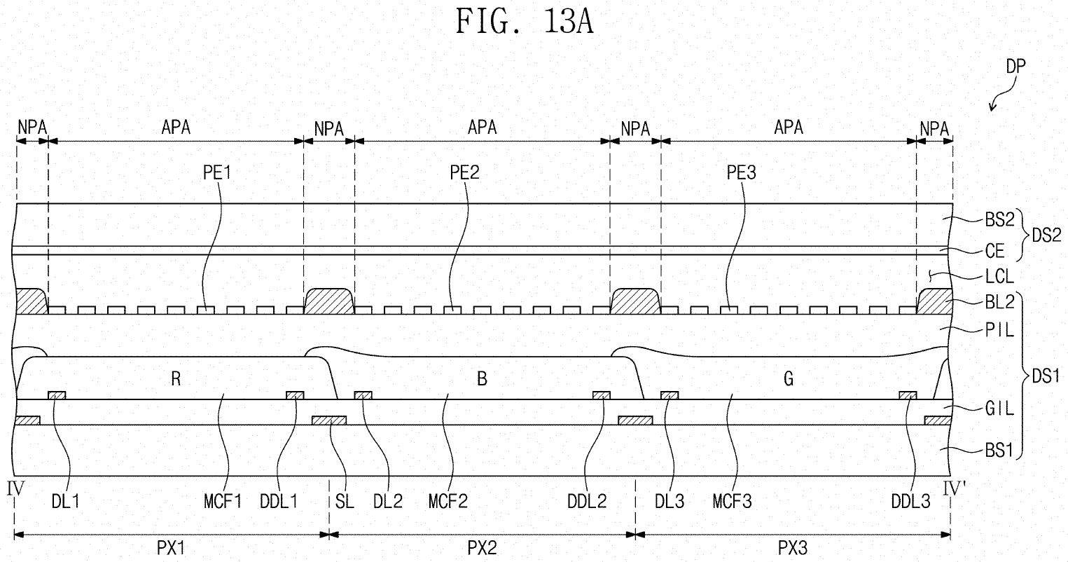

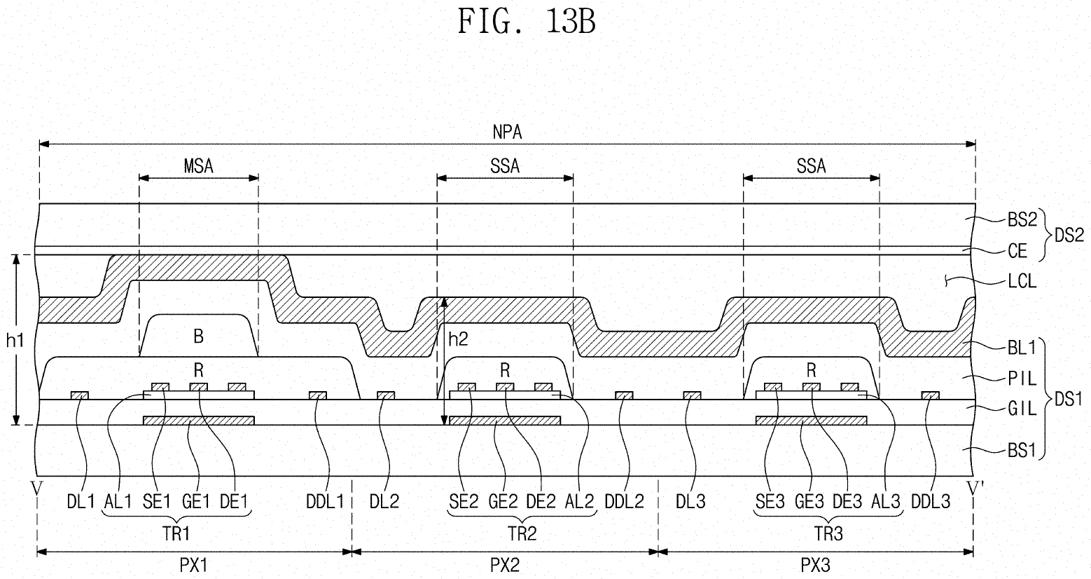

Referring to FIGS. 8A and 8B, in an exemplary embodiment, the first substrate DS1 includes a first base substrate BS1, gate metal layers GL1, GE1, GE2 and SL, a gate insulating layer GIL, an active layer AL, data metal layers DL1 to DL4, SE1, SE2, DE1 and DE2 (or SE3, GE3 and DE3 in FIGS. 13B), color filter layers MCF1, MCF2, SCF1 and SCF2, a planarization layer PIL, the first and second pixel electrodes PE1 and PE2, and the light blocking layers BL1 and BL2.

The first base substrate BS1 may be a transparent or opaque insulating substrate, e.g., a silicon substrate, a glass substrate, and a plastic substrate. The gate metal layers GL1, GE1, GE2, and SL may be disposed on the first base substrate BS1 to correspond to the non-active pixel area NPA. The gate metal layers GL1, GE1, GE2 and SL may include the gate line GL1 and the first and second gate electrodes GE1 and GE2 extending from the first gate line GL1. The gate metal layers GL1, GE1, GE2 and SL may further include the storage line SL. The first gate electrode GE1 may be a control electrode of the first transistor TR1 in the first pixel PX1 (refer to FIG. 5), and the second gate electrode GE2 may be a control electrode of the second transistor TR2 in the second pixel PX2 (refer to FIG. 5). The gate insulating layer GIL is disposed on the first base substrate BS1 to cover the gate metal layers GL1, GE1, GE2 and SL. The gate insulating layer GIL may be an inorganic insulating layer including an inorganic material.

First and second active layers AL1 and AL2 (or a third active layer AL3 in FIG. 13B) may be disposed on the gate insulating layer GIL. The first and second active layers AL1 and AL2 may be semiconductor layers that form a conductive channel between input and output electrodes of the first and second transistors TR1 and TR2. The first substrate DS1 may further include first and second ohmic contact layers disposed above the first and second active layers AL1 and AL2. Each of the first and second active layers AL1 and AL2 may include at least one selected from amorphous silicon, polysilicon, and metal oxide semiconductor.

The data metal layers DL1 to DL4, SE1, SE2, DE1 and DE2 may be disposed on the gate insulating layer GIL. The data metal layers DL1 to DL4, SE1, SE2, DE1 and DE2 may include first to fourth data lines DL1 to DL4, first and second source electrodes SE1 and SE2, and first and second drain electrodes DE1 and DE2. The first source electrode SE1 and the first drain electrode DE1 may be disposed on the first active layer ALl. The first source electrode SE1 and the first drain electrode DE1 may be the input and output electrodes of the first transistor TR1, respectively. The second source electrode SE2 and the second drain electrode DE2 may be disposed on the second active layer AL2. The second source electrode SE2 and the second drain electrode DE2 may be the input and output electrodes of the second transistor TR2, respectively.

The first to fourth data lines DL1 to DL4 are disposed on the gate insulating layer GIL. FIGS. 8A and 8B show an exemplary embodiment with a structure in which the active layer is not disposed under the first to fourth data lines DL1 to DL4, however, the disclosure is not limited thereto or thereby. In one alternative exemplary embodiment, for example, in a case where the first and second active layers AL1 and AL2 and the data metal layers are substantially simultaneously patterned to reduce the number of masks, the active layer may be disposed under the first to fourth data lines DL1 to DL4.

The color filter layers MCF1, MCF2, SCF1 and SCF2 are disposed to cover the data metal layers DL1 to DL4, SE1, SE2, DE1 and DE2. The color filter layers MCF1, MCF2, SCF1 and SCF2 include the first main color filter MCF1 and the first sub-color filter SCF1, which are disposed in the first pixel area PXA1, and the second main color filter MCF2 and the second sub-color filter SCF2, which are disposed in the second pixel area PXA2. The first and second main color filters MCF1 and MCF2 make contact with the active pixel area APA, and the first and second sub-color filters SCF1 and SCF2 make contact with the non-active pixel area NPA.

The first and second main color filters MCF1 and MCF2 may have different colors from each other and may overlap each other in the non-active pixel area NPA. In one exemplary embodiment, for example, the first main color filter MCF1 may have a red color R, and the second main color filter MCF2 may have a blue color B.

The first sub-color filter SCF1 may have a different color from the first main color filter MCF1 and may be disposed on the first main color filter MCF1. The first sub-color filter SCF1 may have substantially the same color as the second main color filter MCF2. In one exemplary embodiment, for example, the first sub-color filter SCF1 may have the blue color B.

The second sub-color filter SCF2 may have a different color from the second main color filter MCF2 and may be disposed spaced apart from the second main color filter MCF2. The second sub-color filter SCF2 may have substantially the same color as the first main color filter MCF1. In one exemplary embodiment, for example, the second sub-color filter SCF2 may have the red color R.

The planarization layer PIL may be disposed on the color filter layers MCF1, MCF2, SCF1, and SCF2. The planarization layer PIL may be an insulating layer including or formed of an organic material. In an exemplary embodiment, a passivation layer including or formed of an inorganic material may be further disposed between the planarization layer PIL and the color filter layers MCF1, MCF2, SCF1 and SCF2. The first substrate DS1 may selectively include the passivation layer or the planarization layer PIL, or may include both of the passivation layer or the planarization layer PIL.

In an exemplary embodiment, an area in which the color filter layers MCF1, MCF2, SCF1 and SCF2 are not disposed in the non-active pixel area NPA may be directly covered by the planarization layer PIL.

A contact portion may be defined in the planarization layer PIL and the color filter layers MCF1 and MCF2 to expose a portion of the data metal layers DL1 to DL4, SE1, SE2, DE1 and DE2. The contact portion may include the first and second contact portions CNT1 and CNT2 (refer to FIG. 5) to respectively expose the first drain electrode DE1 of the first transistor TR1 and the second drain electrode DE2 of the second transistor TR2 in the first and second pixels PX1 and PX2.

The pixel electrodes PE1 and PE2 are disposed on the planarization layer PIL. The first pixel electrode PE1 among the pixel electrodes PE1 and PE2 is disposed in the first pixel PX1, and the second pixel electrode PE2 among the pixel electrodes PE1 and PE2 is disposed in the second pixel PX2. The first pixel electrode PE1 makes contact with or electrically connected to the first drain electrode DE1 of the first transistor TR1 through the first contact portion CNT1, and the second pixel electrode PE2 makes contact with or electrically connected to the second drain electrode DE2 of the second transistor TR2 through the second contact portion CNT2.

The light blocking layers BL1 and BL2 are disposed on the planarization layer PIL in the non-active pixel area NPA. The light blocking layers BL1 and BL2 include an organic material containing a light blocking material, e.g., carbon, that blocks the light. The light blocking layers BL1 and BL2 have a black color.

The light blocking layers BL1 and BL2 may include a plurality of first light blocking layers BL1 and a plurality of second light blocking layers BL2. Each of the second light blocking layers BL2 may be disposed to overlap two pixels PX1 and PX2 adjacent to each other in the second direction DR2. In an exemplary embodiment, as shown in FIG. 8A, at least one of the second light blocking layers BL2 overlaps the first and second main color filters MCF1 and MCF2 in the non-active pixel area NPA.

Referring to FIG. 9A, in an exemplary embodiment, the second light blocking layer BL2 may have a width W1 that is equal to a distance d1 between the first pixel electrode PE1 and the second pixel electrode PE2. Accordingly, in such an embodiment, the second light blocking layer BL2 may not overlap the pixel electrodes PE1 and PE2. The second light blocking layer BL2 is disposed between two data lines DDL1 and DL2 adjacent to each other. In such an embodiment, the second light blocking layer BL2 may not overlap the data lines DL1, DDL1, DL2 and DDL2.

The second light blocking layer BL2 may be disposed to correspond to an area overlapping the two main color filters MCF1 and MCF2. Accordingly, in such an embodiment, the second light blocking layer BL2 may effectively prevent a phenomenon that may occur when different color lights are mixed with each other between the pixel areas PXA1 and PXA2 due to the overlap of the two main color filters MCF1 and MCF2 from being perceived.

Referring to FIG. 9B, in an alternative exemplary embodiment, the second light blocking layer BL2 may have a width W2 greater than the distance d1 between the first pixel electrode PE1 and the second pixel electrode PE2. Accordingly, in such an embodiment, the second light blocking layer BL2 may partially overlap the pixel electrodes PE1 and PE2. In such an embodiment, the width W2 of the second light blocking layer BL2 may be less than a distance d2 between two data lines DDL1 and DL2 adjacent to each other. Accordingly, in such an embodiment, the second light blocking layer BL2 may not overlap the data lines DL1, DDL1, DL2 and DDL2.

Referring back to FIG. 8B, the first light blocking layer BL1 may extend in the second direction DR2 and may cover the pixel circuit of each of the pixels PX1 and PX2. The first light blocking layer BL1 may overlap the sub-color filters SCF1 and SCF2 of each of the pixels PX1 and PX2. In such an embodiment, the first light blocking layer BL1 may overlap the first sub-color filter SCF1 in the non-active pixel area NPA of the first pixel PX1 and may overlap the second sub-color filter SCF2 in the non-active pixel area NPA of the second pixel PX2. In such an embodiment, the area, in which the first sub-color filter SCF1 is disposed, may be defined as a main spacer area MSA, and the area, in which the second sub-color filter SCF2 is disposed, may be defined as a sub-spacer area SSA.

The first sub-color filter SCF1 is disposed on the first main color filter MCF1 in the non-active pixel area NPA of the first pixel PX1, and the second sub-color filter SCF2 is disposed on the gate insulating layer GIL in the non-active pixel area NPA of the second pixel PX2. The second sub-color filter SCF2 directly makes contact with the second transistor TR2 on the gate insulating layer GIL.

In an exemplary embodiment, the first main color filter MCF1 is disposed between the first light blocking layer BL1 and the gate insulating layer GIL in the first pixel PX1, and the second main color filter MCF2 is not disposed between the first light blocking layer BL1 and the gate insulating layer GIL in the second pixel PX2. Accordingly, in such an embodiment, a difference in height occurs between the first light blocking layer BL1 of the first pixel PX1 and the second light blocking layer BL2 of the second pixel PX2. In such an embodiment, the difference in height occuring between the first light blocking layer BL1 of the first pixel PX1 and the second light blocking layer BL2 of the second pixel PX2 allows the first light blocking layer BL1 to have the height difference between the main spacer area MSA and the sub-spacer area SSA. In such an embodiment, where the first light blocking layer BL1 is located at a first height h1 from the first base substrate BS1 in the main spacer area MSA, the first light blocking layer BL1 is located at a second height h2 from the first base substrate BS1, which is lower than the first height h1, in the sub-spacer area SSA.

The first substrate DS1 may further include a first alignment layer disposed on the light blocking layers BL1 and BL2, the planarization layer PIL and the pixel electrodes PE1 and PE2.

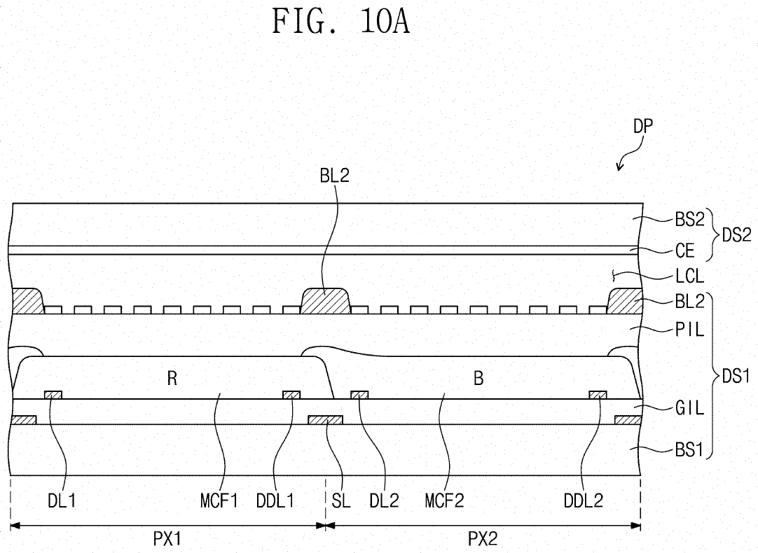

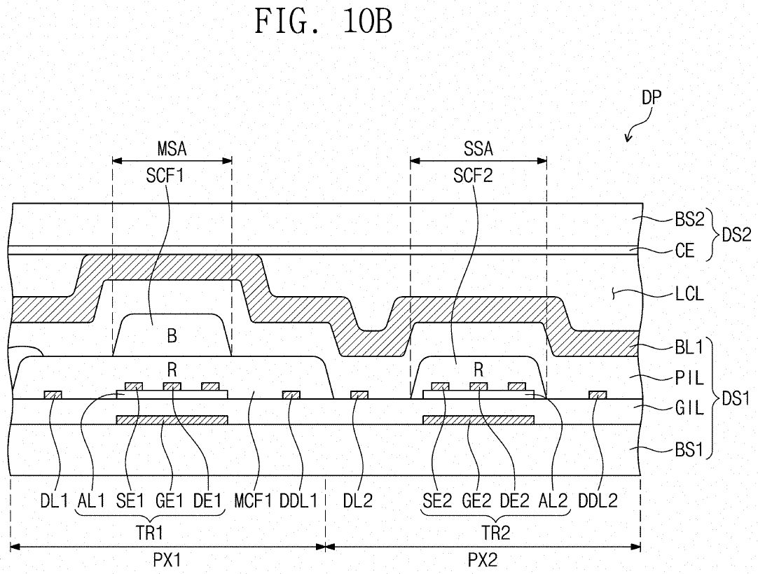

FIG. 10A is a cross-sectional view showing the first substrate DS1 of FIG. 8A coupled to a second substrate DS2, and FIG. 10B is a cross-sectional view showing the first substrate DS1 of FIG. 8B coupled to the second substrate DS2.

Referring to FIGS. 10A and 10B, in an exemplary embodiment, the second substrate DS2 includes a second base substrate BS2 and a common electrode CE. The second base substrate BS2 is disposed to face the first base substrate BS1. The second base substrate BS2 may be transparent or opaque insulating substrate, e.g., a silicon substrate, a glass substrate, and a plastic substrate.

The common electrode CE is disposed on the second base substrate BS2. The common electrode CE is disposed on a surface of the second base substrate BS2, which faces the first base substrate BS1. The common voltage is applied to the common electrode CE. The electric field may be generated between the pixel electrodes PE1 and PE2 and the common electrode CE. The second substrate DS2 may further include a second alignment layer disposed on the common electrode CE.

A liquid crystal layer LCL is disposed between the first substrate DS1 and the second substrate DS2. When the electric field is generated between the pixel electrodes PE1 and PE2 and the common electrode CE, the liquid crystal layer LCL is driven by the electric field. A light transmittance of the liquid crystal layer LCL is controlled by an intensity of the electric field.

The first and second substrates DS1 and DS2 may be spaced apart from each other by a predetermined distance to provide a space therebetween in which the liquid crystal layer LCL is disposed. The display panel may include the spacer areas MSA and SSA to uniformly maintain the distance between the first and second substrates DS1 and DS2. In an exemplary embodiment, the spacer areas MSA and SSA may include the main spacer area MSA and the sub-spacer area SSA.

In an exemplary embodiment, as shown in FIG. 10B, the first and second substrates DS1 and DS2 may make contact with each other in the main spacer area MSA. In such an embodiment, the main spacer area MSA may be provided in the pixel PX1 among the pixels PX1 and PX2. Substantially, the distance between the first and second substrates DS1 and DS2 may be maintained by the main spacer area MSA. The first and second substrates DS1 and DS2 may be spaced apart from each other in the sub-spacer area SSA. The sub-spacer area SSA may serve as a buffer against impacts applied to the main spacer area MSA.

In an exemplary embodiment, as described above, the display panel DP may have a structure in which the first light blocking layer BL1 overlaps the first and second sub-color filters SCF1 and SCF2, and thus the spacer areas MSA and SSA may be effectively provided or defined in the display panel DP without forming or providing a separate spacer between the first substrate DS1 and the second substrate DS2. In such an embodiment, since the first and second sub-color filters SCF1 and SCF2 may be formed together with the first and second main color filters MCF1 and MCF2, the first and second sub-color filters SCF1 and SCF2 may be effectively provided or formed without an additional process. Accordingly, a process for forming a separate spacer may be omitted, and thus the manufacturing process of the display panel DP may be simplified.

In an exemplary embodiment, the display panel DP may further include a sealant to couple the first and second substrates DS1 and DS2 and to seal the space between the first and second substrates DS1 and DS2. The sealant may be disposed in the non-display area NDA (refer to FIG. 2) of the display panel DP.

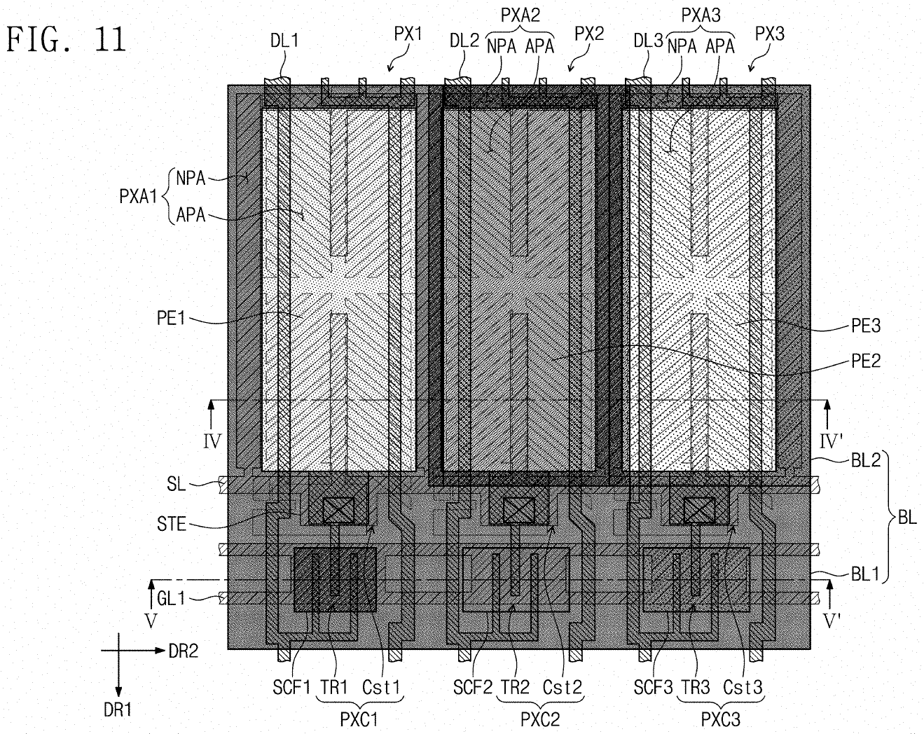

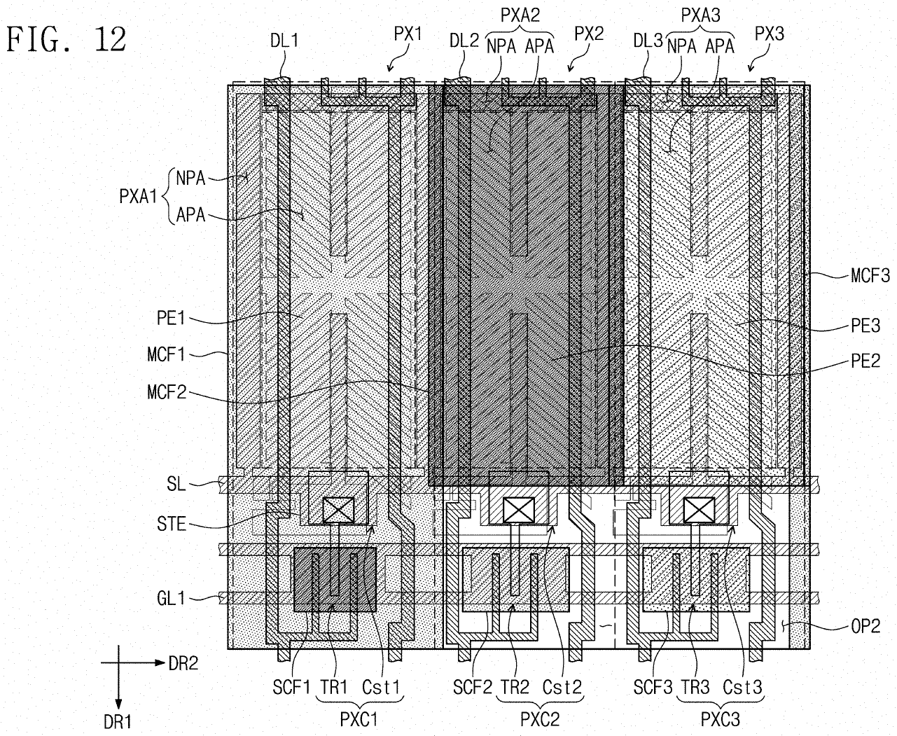

FIG. 11 is a plan view showing a pixel area of a first substrate according to an exemplary embodiment of the disclosure, and FIG. 12 is a plan view showing the first substrate of FIG. 11, from which a light blocking layer is removed. FIG. 13A is a cross-sectional view taken along line IV-IV′ shown in FIG. 11 to show the first substrate coupled to the second substrate, and FIG. 13B is a cross-sectional view taken along line V-V′ shown in FIG. 11 to show the first substrate coupled to the second substrate.

The display area DA (refer to FIG. 2) of the first substrate DS1 includes a plurality of pixel areas. FIGS. 11, 12, 13A and 13B show first, second and third pixel areas PXA1, PXA2, and PXA3 among the pixel areas.

Referring to FIGS. 11 and 12, the first substrate DS1 includes a first pixel PX1 disposed in the first pixel area PXA1, a second pixel PX2 disposed in the second pixel area PXA2, and a third pixel PX3 disposed in the third pixel area PXA3. The first pixel PX1 includes a first pixel circuit PXC1 and a first pixel electrode PE1, the second pixel PX2 includes a second pixel circuit PXC2 and a second pixel electrode PE2, and the third pixel PX3 includes a third pixel circuit PXC3 and a third pixel electrode PE3. The first pixel circuit PXC1 is connected to a firs gate line GL1 and a first data line DL1, the second pixel circuit PXC2 is connected to the first gate line GL1 and a second data line DL2, and the third pixel circuit PXC3 is connected to the first gate line GL1 and a third data line DL3.

The first pixel circuit PXC1 includes a first transistor TR1 and a first storage capacitor Cst1, the second pixel circuit PXC2 includes a second transistor TR2 and a second storage capacitor Cst2, and the third pixel circuit PXC3 includes a third transistor TR3 and a third storage capacitor Cst3.

Each of the first to third pixel areas PXA1 to PXA3 includes an active pixel area APA and a non-active pixel area NPA. The first to third pixel electrodes PE1 to PE3 overlap the active pixel area APA, and the first to third pixel circuits PXC1 to PXC3 overlap the non-active pixel area NPA.

The first gate line GL1 and the first and second data lines DL1 and DL2 may be disposed in the non-active pixel area NPA. In an exemplary embodiment, portions of the first and second data lines DL1 and DL2 may overlap the active pixel area APA.

The first substrate DS1 may include a light blocking layer BL that defines the non-active pixel area NPA. The light blocking layer BL may be disposed in the non-active pixel area NPA to cover the first to third pixel circuits PXC1 to PXC3 and the first gate line GL1. The light blocking layer BL may partially cover the first and second data lines DL1 and DL2. The light blocking layer BL may include a plurality of first light blocking layers BL1 and a plurality of second light blocking layers BL2. The first light blocking layers BL1 may extend in the second direction DR2 and may be spaced apart from each other while being arranged in the first direction DR1. The second light blocking layers BL2 may extend in the first direction DR1 and may be spaced apart from each other while being arranged in the second direction DR2. Each of the first light blocking layers BL1 may be connected to the second light blocking layers BL2. The second direction DR2 may be substantially perpendicular to the first direction DR1.

Each of the first to third pixel circuits PXC1 to PXC3 and the first gate line GL1 are covered by one corresponding first light blocking layer among the first light blocking layers BL1. The first to third data lines DL1 to DL3 overlap the first light blocking layers BL1 and do not overlap the second light blocking layers BL2.

The first pixel PX1 may include a first main color filter MCF1 and a first sub-color filter SCF1. The second pixel PX2 may include a second main color filter MCF2 and a second sub-color filter SCF2. The third pixel PX3 may include a third main color filter MCF3 and a third sub-color filter SCF3.

The first main color filter MCF1 may have a color different from colors of the second and third main color filters MCF2 and MCF3, respectively. The first main color filter MCF1 may be provided in plural, and the first main color filters MCF1 may be arranged in the second direction DR2. The first main color filters MCF1 may be connected to each other to be integrally formed with each other in a single unitary unit.

The first main color filter MCF1 may be disposed in the active pixel area APA and the non-active pixel area NPA of the first pixel area PXA1. The first main color filter MCF1 may cover the first pixel circuit PXC 1 in the non-active pixel area NPA.

The second main color filter MCF2 may be disposed in the active pixel area APA of the second pixel area PXA2. A first opening may be defined through the second main color filter MCF2 in the non-active pixel area NPA. The second pixel circuit PXC2 may be partially exposed through the first opening defined through the second main color filter MCF2. In such an embodiment, the second main color filter MCF2 may not overlap a contact portion of the second pixel circuit PXC2. The contact portion of the second pixel circuit PXC2 may be exposed through the first opening.

The third main color filter MCF3 may be disposed in the active pixel area APA of the third pixel area PXA3. A second opening may be defined through the third main color filter MCF3 in the non-active pixel area NPA. The third pixel circuit PXC3 may be partially exposed through the second opening defined through the third main color filter MCF3. In such an embodiment, the third main color filter MCF3 may not overlap a contact portion of the third pixel circuit PXC3. The contact portion of the third pixel circuit PXC3 may be exposed through the second opening.

Each of the first to third main color filters MCF1 to MFC3 may be disposed to partially overlap the main color filter of an adjacent pixel area thereof.

In an exemplary embodiment, as shown in FIG. 13A, the first and second main color filters MCF1 and MCF2 may have different colors from each other, the first and second main color filters MCF1 and MCF2 may overlap each other in the non-active pixel area NPA, and the second and third main color filters MCF2 and MCF3 may overlap each other in the non-active pixel area NPA. In one exemplary embodiment, for example, the first main color filter MCF1 may have a red color R, the second main color filter MCF2 may have a blue color B, and the third main color filter MCF3 may have a green color G

Referring to FIGS. 12 and 13B, the first sub-color filter SCF1 may have a color different from a color of the first main color filter MCF1. The first sub-color filter SCF1 may have substantially a same color as one of the second and third main color filters MCF2 and MCF3. In an exemplary embodiment, the first sub-color filter SCF1 may have one color of the blue color B and the green color G In an exemplary embodiment, as shown in FIG. 13B, the first sub-color filter SCF1 has a same color as the second main color filter MCF2 or the blue color B. The first sub-color filter SCF1 may be disposed on the first main color filter MCF1. The first sub-color filter SCF1 may be disposed in the non-active pixel area NPA to overlap the first pixel circuit PXC1. In such an embodiment, the first sub-color filter SCF1 may overlap a first transistor TR1.

The second sub-color filter SCF2 may have a color different from the color of the second main color filter MCF2. In an exemplary embodiment, the second sub-color filter SCF2 may have substantially a same color as the first and third main color filters MCF1 and MCF3. In one exemplary embodiment, for example, the second sub-color filter SCF2 may have the same red color R as the first main color filter MCF1. The second sub-color filter SCF2 may not overlap the second main color filter MCF2. The second sub-color filter SCF2 may be disposed in the non-active pixel area NPA to overlap the second pixel circuit PXC2. In such an embodiment, the second sub-color filter SCF2 may overlap a second transistor TR2.

The third sub-color filter SCF3 may have a color different from the color of the third main color filter MCF3. In an exemplary embodiment, the third sub-color filter SCF3 may have substantially a same color as the first and second main color filters MCF1 and MCF2. In one exemplary embodiment, for example, the third sub-color filter SCF3 may have the same red color R as the first main color filter MCF1. The third sub-color filter SCF3 may not overlap the third main color filter MCF3. The third sub-color filter SCF3 may be disposed in the non-active pixel area NPA to overlap the third pixel circuit PXC3. In such an embodiment, the third sub-color filter SCF3 may overlap a third transistor TR3.

In an exemplary embodiment, as shown in FIGS. 11 and 12, each of the first to third sub-color filters SCF1 to SCF3 has a quadrangular shape when viewed in a plan view, but the shape of the first to third sub-color filters SCF1 to SCF3 is not particularly limited and may be variously modified. In one alternative exemplary embodiment, for example, each of the first to third sub-color filters SCF1 to SCF3 may have a circular shape when viewed in a plan view.

Referring to FIGS. 11, 13A and 13B, the light blocking layer BL may include the first light blocking layers BL1 and the second light blocking layers BL2. The light blocking layer BL may be disposed on a planarization layer PIL. Each of the second light blocking layers BL2 may be disposed to overlap two pixels PX1 and PX2 or PX2 and PX3 that are adjacent to each other in the second direction DR2. In an exemplary embodiment, each of the second light blocking layers BL2 may be disposed between two adjacent data lines DL1 and DDL1, DL2 and DDL2 or DL3 and DDL3. In such an embodiment, the second light blocking layer BL2 may be disposed to correspond to an area in which two main color filters MCF1 and MCF2 or MCF2 and MCF3 overlap each other. Accordingly, the second light blocking layer BL2 may effectively prevent a phenomenon that may occur when different color lights are mixed with each other between the pixel areas PXA1, PXA2, and PXA3 due to the overlap of the two main color filters MCF1 and MCF2 or MCF2 and MCF3, from being perceived.

Each of the second light blocking layers BL2 may not overlap a data line adjacent thereto. In an exemplary embodiment, as shown in FIG. 13A, at least one of the second light blocking layers BL2 may overlap the first, second and third main color filters MCF1, MCF2 and MCF3 in the non-active pixel area NPA.

The first light blocking layer BL1 may extend in the second direction DR2 and may cover the pixel circuits PXC1, PXC2 and PXC3 of the pixels PX1, PX2 and PX3. The first light blocking layer BL1 may overlap the sub-color filters SCF1, SCF2 and SCF3 of the pixels PX1, PX2 and PX3. In such an embodiment, the area in which the first sub-color filter SCF1 is disposed may be defined as a main spacer area MSA, and the area in which the second and third sub-color filters SCF2 and SCF3 are disposed may be defined as a sub-spacer area SSA.

The first sub-color filter SCF1 is disposed on the first main color filter MCF1, and the second and third sub-color filters SCF2 and SCF3 are disposed on the gate insulating layer

GIL. The second and third sub-color filters SCF2 and SCF3 directly contact or make direct contact with the second and third transistors TR2 and TR3, respectively, on the gate insulating layer GIL.

A difference in height occurs between the first light blocking layer BL1 of the first pixel PX1 and the first light blocking layer BL1 of the second and third pixels PX2 and PX3. In such an embodiment, the first light blocking layer BL1 has the height difference between the main spacer area MSA and the sub-spacer area SSA. In an exemplary embodiment, where the first light blocking layer BL1 is located at a first height h1 from the first base substrate BS1 in the main spacer area MSA, the first light blocking layer BL1 is located at a second height h2 from the first base substrate BS1, which is lower than the first height h1, in the sub-spacer area SSA.

Accordingly, in such an embodiment, the first and second substrates DS1 and DS2 may make contact with each other in the main spacer area MSA, and thus the distance between the first and second substrates DS1 and DS2 may be maintained by the main spacer area MSA. In such an embodiment, the first and second substrates DS1 and DS2 may be spaced apart from each other in the sub-spacer area SSA. The sub-spacer area SSA may serve as a buffer against impacts applied to the main spacer area MSA.

In an exemplary embodiment, as described above, the display panel DP may have a structure in which the first light blocking layer BL1 overlaps the first and second sub-color filters SCF1 and SCF2, and thus the display panel DP may include the spacer areas MSA and SSA without forming a separate spacer between the first substrate DS1 and the second substrate DS2. In such an embodiment, since the first to third sub-color filters SCF1 to SCF3 may be formed together with the first to third main color filters MCF1 to MCF3, the first to third sub-color filters SCF1 to SCF3 may be effectively provided or formed without any additional process. Therefore, in such an embodiment, the process for forming the separate spacer may be omitted, and thus the manufacturing process of the display panel DP may be simplified.

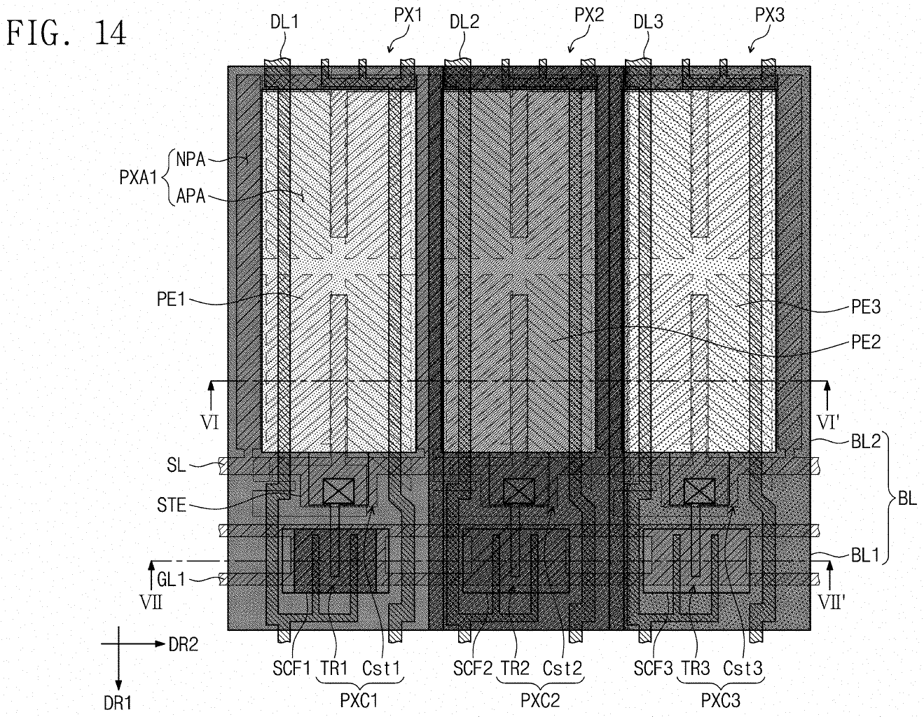

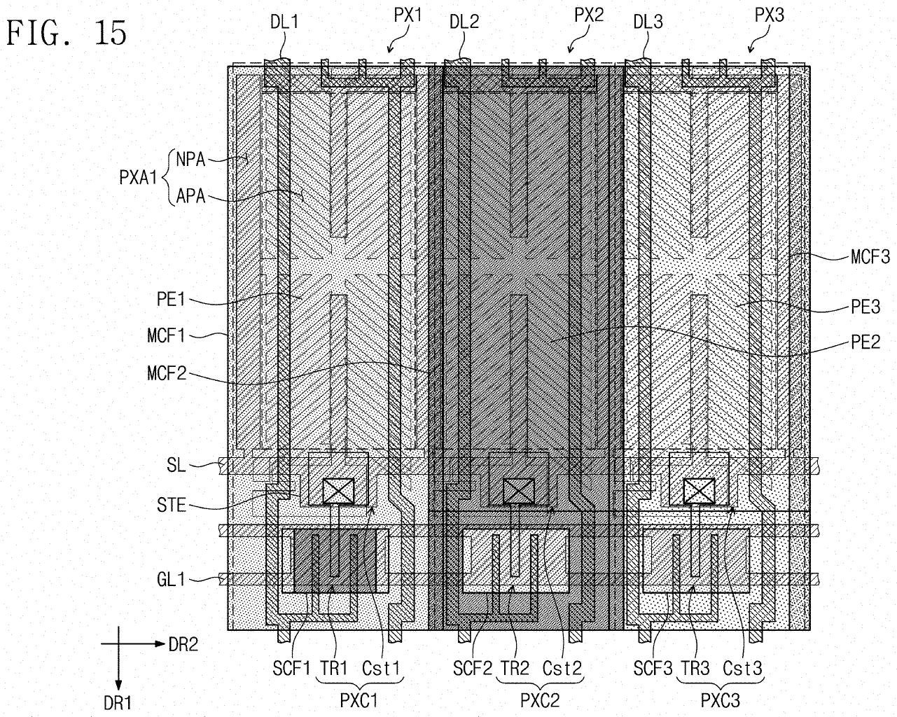

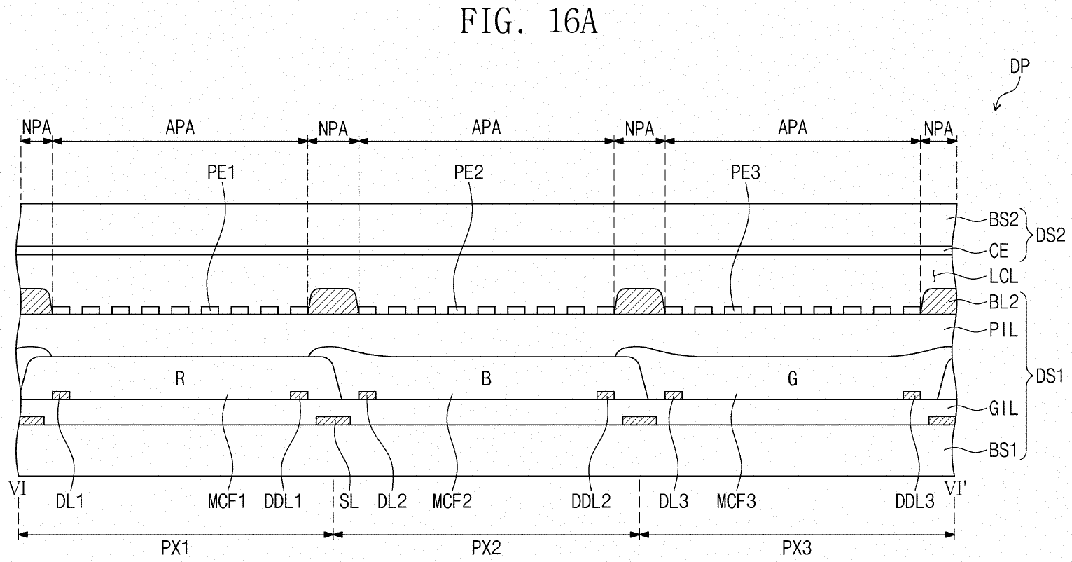

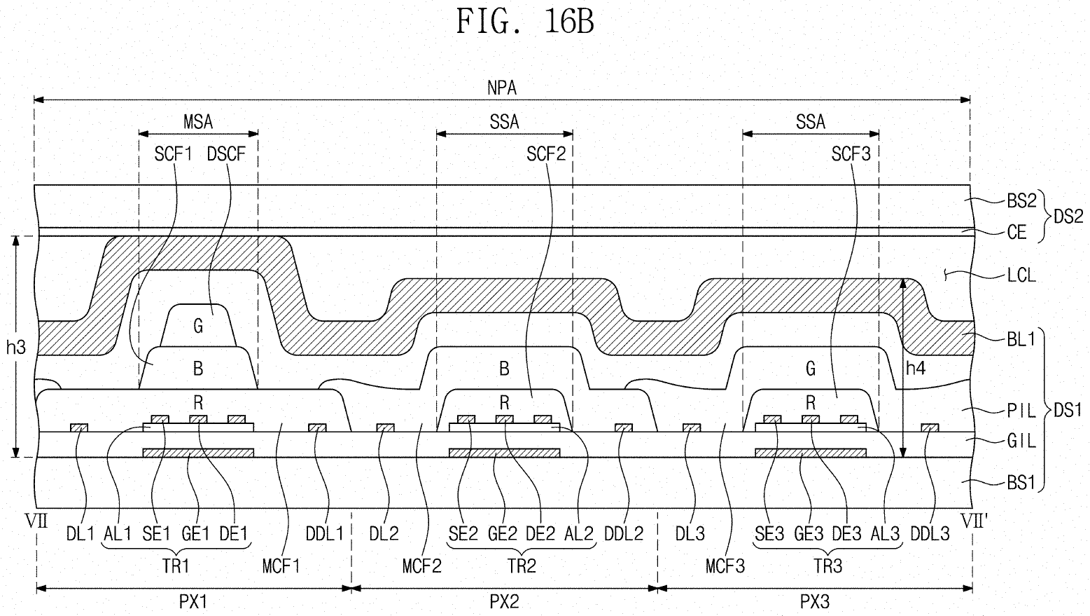

FIG. 14 is a plan view showing a pixel area of a first substrate according to an exemplary embodiment of the disclosure, and FIG. 15 is a plan view showing the first substrate of FIG. 14, from which a light blocking layer is removed. FIG. 16A is a cross-sectional view taken along line VI-VI′ shown in FIG. 14 to show the first substrate, and FIG. 16B is a cross-sectional view taken along line VII-VII′ shown in FIG. 14 to show the first substrate.

Referring to FIGS. 14 and 15, a first pixel PX1 includes a first main color filter MCF1, a first sub-color filter SCF1, and a dummy sub-color filter DSCF. A second pixel PX2 includes a second main color filter MCF2 and a second sub-color filter SCF2. A third pixel PX3 includes a third main color filter MCF3 and a third sub-color filter SCF3.

The first main color filter MCF1 may be disposed in an active pixel area APA and a non-active pixel area NPA of a first pixel area PXA1. The first main color filter MCF1 may cover a first pixel circuit PXC1 in the non-active pixel area NPA. The second main color filter MCF2 may be disposed in an active pixel area APA and a non-active pixel area NPA of a second pixel area PXA2. The second main color filter MCF2 may cover a second pixel circuit PXC2 in the non-active pixel area NPA. The third main color filter MCF3 may be disposed in an active pixel area APA and a non-active pixel area NPA of a third pixel area PXA3. The third main color filter MCF3 may cover a third pixel circuit PXC3 in the non-active pixel area NPA. Each of the first to third main color filters MCF1 to MCF3 may be disposed to partially overlap the main color filter of an adjacent pixel area thereof.

In an exemplary embodiment, as shown in FIG. 16A, the first and second main color filters MCF1 and MCF2 may have different colors from each other, the first and second main color filters MCF1 and MCF2 may overlap each other in the non-active pixel area NPA, and the second and third main color filters MCF2 and MCF3 may overlap each other in the non-active pixel area NPA. In one exemplary embodiment, for example, the first main color filter MCF1 may have a red color R, the second main color filter MCF2 may have a blue color B, and the third main color filter MCF3 may have a green color G

Referring to FIGS. 15 and 16B, the first sub-color filter SCF1 may be disposed on the first main color filter MCF1, and the dummy sub-color filter DSCF may be disposed on the first sub-color filter SCF1. The first sub-color filter SCF1 and the dummy sub-color filter DSCF may be disposed in the non-active pixel area NPA to overlap the first pixel circuit PXC1. In an exemplary embodiment, the first sub-color filter SCF1 and the dummy sub-color filter DSCF may overlap a first transistor TR1. The first sub-color filter SCF1 and the dummy sub-color filter DSCF may have different colors from each other. The first sub-color filter SCF1 and the dummy sub-color filter DSCF may have a different color from the first main color filter MCF1. In one exemplary embodiment, for example, the first sub-color filter SCF1 may have the same blue color B as the second main color filter MCF2, and the dummy sub-color filter DSCF may have the same green color G as the third main color filter MCF3.

The second sub-color filter SCF2 may have a different color from the second main color filter MCF2. In one exemplary embodiment, for example, the second sub-color filter SCF2 may have the same red color R as the first main color filter MCF1. The second sub-color filter SCF2 may overlap the second main color filter MCF2. The second main color filter MCF2 may cover the second sub-color filter SCF2 in the non-active pixel area NPA. The second sub-color filter SCF2 may be disposed in the non-active pixel area NPA to overlap the second pixel circuit PXC2. In such an embodiment, the second sub-color filter SCF2 may overlap a second transistor TR2.

The third sub-color filter SCF3 may have a different color from the third main color filter MCF3. In one exemplary embodiment, for example, the third sub-color filter SCF3 may have the same red color (R) as the first main color filter MCF1. The third sub-color filter SCF3 may overlap the third main color filter MCF3. The third main color filter MCF3 may cover the third sub-color filter SCF3 in the non-active pixel area NPA. The third sub-color filter SCF3 may be disposed in the non-active pixel area NPA to overlap the third pixel circuit PXC3. In such an embodiment, the third sub-color filter SCF3 may overlap a third transistor TR3.

Referring to FIGS. 14, 16A, and 16B, a light blocking layer BL may include a plurality of first light blocking layers BL1 and a plurality of second light blocking layers BL2. The light blocking layer BL may be disposed on a planarization layer PIL of the first substrate DS1. Each of the second light blocking layers BL2 may be disposed to overlap two pixels PX1 and PX2 or PX2 and PX3 that are adjacent to each other in the second direction DR2. In an exemplary embodiment, as shown in FIG. 16A, at least one of the second light blocking layers BL2 may overlap the first, second, and third main color filters MCF1, MCF2, and MCF3 in the non-active pixel area NPA.

The first light blocking layer BL1 may extend in the second direction DR2 and may cover the pixel circuits PXC1, PXC2, and PXC3 of the pixels PX1, PX2, and PX3. In an exemplary embodiment, the first light blocking layer BL1 may overlap the sub-color filters SCF1, SCF2, and SCF3 of each of the pixels PX1, PX2, and PX3 and the dummy sub-color filter DSCF. In such an embodiment, the area, in which the first sub-color filter SCF1 and the dummy sub-color filter DSCF are disposed, may be defined as a main spacer area MSA, and the area, in which the second and third sub-color filters SCF2 and SCF3 are disposed, may be defined as a sub-spacer area SSA.

The first sub-color filter SCF1 is disposed on the first main color filter MCF1, and the dummy sub-color filter DSCF is disposed on the first sub-color filter SCF1. The second and third sub-color filters SCF2 and SCF3 are disposed on a gate insulating layer GIL. The second and third sub-color filters SCF2 and SCF3 directly contact or make direct contact with the second and third transistors TR2 and TR3, respectively, on the gate insulating layer GIL.

A difference in height occurs between the first light blocking layer BL1 of the first pixel PX1 and the first light blocking layer BL1 of the second and third pixels PX2 and PX3. In such an embodiment, the first light blocking layer BL1 has the height difference between the main spacer area MSA and the sub-spacer area SSA. In such an embodiment, where the first light blocking layer BL1 is located at a third height h3 from the first base substrate BS1 in the main spacer area MSA, the first light blocking layer BL1 is located at a fourth height h4 from the first base substrate BS1, which is lower than the third height h3, in the sub-spacer area SSA.

Accordingly, in such an embodiment, the first and second substrates DS1 and DS2 may make contact with each other in the main spacer area MSA, and thus the distance between the first and second substrates DS1 and DS2 may be maintained by the main spacer area MSA. In such an embodiment, the first and second substrates DS1 and DS2 may be spaced apart from each other in the sub-spacer area SSA. The sub-spacer area SSA may serve as a buffer against impacts applied to the main spacer area MSA.

In such an embodiment, the height of the first light blocking layer BL1 from the first base substrate BS1 in the main spacer area MSA may be controlled by adjusting the number or thickness of color filters interposed between the first light blocking layer BL1 and the first base substrate BS1.

The invention should not be construed as being limited to the exemplary embodiments set forth herein. Rather, these exemplary embodiments are provided so that this disclosure will be thorough and complete and will fully convey the concept of the invention to those skilled in the art.

While the invention has been particularly shown and described with reference to exemplary embodiments thereof, it will be understood by those of ordinary skill in the art that various changes in form and details may be made therein without departing from the spirit or scope of the invention as defined by the following claims.

What is claimed is:

1. A display device comprising:
a plurality of data lines extending in a first direction;
a plurality of gate lines extending in a second direction;
a first pixel circuit connected to a corresponding data line among the data lines and a corresponding gate line among the gate lines;
a second pixel circuit connected to a corresponding data line among the data lines and a corresponding gate line among the gate lines;
a first pixel electrode connected to the first pixel circuit and disposed in a first pixel area;
a second pixel electrode connected to the second pixel circuit and disposed in a second pixel area;
a first main color filter disposed in the first pixel area and having a first color;
a second main color filter disposed in the second pixel area and having a second color;
a first sub-color filter overlapping the first pixel circuit and having the second color;
a first light blocking layer extending in the second direction and overlapping the gate lines; and
a second light blocking layer extending in the first direction from the first light blocking layer.

2. The display device of claim 1, wherein the first light blocking layer overlaps the first sub-color filter.

3. The display device of claim 1, wherein the first sub-color filter is disposed on the first main color filter.

4. The display device of claim 3, wherein the first main color filter overlaps the first pixel circuit.

5. The display device of claim 1, further comprising:
a second sub-color filter overlapping the second pixel circuit.

6. The display device of claim 5, wherein the first light blocking layer overlaps the second sub-color filter.

7. The display device of claim 5, wherein the second main color filter does not overlap the second sub-color filter.

8. The display device of claim 5, wherein the second main color filter covers the second sub-color filter.

9. The display device of claim 5, wherein the second sub-color filter comprises the first color.

10. The display device of claim 1, further comprising:
an insulating layer which covers the first main color filter, the second main color filter and the first sub-color filter,
wherein the first and second light blocking layers are disposed on the insulating layer.

11. The display device of claim 1, wherein
the first and second main color filters overlap each other in the second direction, and
the second light blocking layer is disposed to correspond to an area in which the first and second main color filters overlap each other.

12. The display device of claim 11, wherein the second light blocking layer has a width equal to or greater than a distance in the second direction between the first and second pixel electrodes.

13. A display device comprising:
a plurality of data lines extending in a first direction;
a plurality of gate lines extending in a second direction;
a first pixel circuit connected to a corresponding data line among the data lines and a corresponding gate line among the gate lines;
a second pixel circuit connected to a corresponding data line among the data lines and a corresponding gate line among the gate lines;
a third pixel circuit connected to a corresponding data line among the data lines and a corresponding gate line among the gate lines;
a first pixel electrode connected to the first pixel circuit and disposed in a first pixel area;
a second pixel electrode connected to the second pixel circuit and disposed in a second pixel area;
a third pixel electrode connected to the third pixel circuit and disposed in a third pixel area;
a first main color filter disposed in the first pixel area and having a first color;
a second main color filter disposed in the second pixel area and having a second color;
a third main color filter disposed in the third pixel area and having a third color;
a first sub-color filter overlapping the first pixel circuit and having a color different from the first color;
a second sub-color filter overlapping at least one of the second and third pixel circuits;
a first light blocking layer extending in the second direction and overlapping the gate lines, the first sub-color filter and the second sub-color filter; and
a second light blocking layer extending in the first direction from the first light blocking layer.

14. The display device of claim 13, wherein the first sub-color filter has one of the second and third colors.

15. The display device of claim 13, wherein the second sub-color filter has the first color.

16. The display device of claim 14, further comprising:
a dummy sub-color filter disposed on the first sub-color filter to overlap the first pixel circuit.

17. The display device of claim 16, wherein the dummy sub-color filter has a color different from colors of the first sub-color filter and the first main color filter.

18. The display device of claim 13, further comprising:
an insulating layer which covers the first second and third main color filters and the first and second sub-color filters,
wherein the first and second light blocking layers are disposed on the insulating layer.

19. The display device of claim 13, wherein
adjacent color filters in the second direction among the first, second and third main color filters overlap each other, and
the second light blocking layer is disposed to correspond to an area in which the first, second and third main color filters overlap each other.

20. The display device of claim 19, wherein the second light blocking layer does not overlap the data lines.
